(19) United States
(12) Patent Application Publication
(10) Pub. No.: US 2026/0225853 A1
(43) Pub. Date: Aug. 6, 2026

(54) CUSTOMIZABLE RESIDENTIAL LIFT ENCLOSURE AND LIFT

(71) Applicant: Jacqueline Margulies, East Stroudsburg, PA (US)

(72) Inventor: Jacqueline Margulies, East Stroudsburg, PA (US)

(21) Appl. No.: 19/042,680

(22) Filed: Jan. 31, 2025

(51) Int. Cl. B66B 9/16; B66B 11/04; B66B 13/04

(52) U.S. Cl. CPC B66B 9/16; B66B 11/0492; B66B 13/04

(57) ABSTRACT

A housing includes a plurality of footings; a plurality of corner posts, each of the plurality of corner posts anchored to a different one of the plurality of footings; a plurality of interior frames, disposed in between less than all of the plurality of corner posts to form a plurality of exterior wall frames and a door frame; a plurality of exterior walls, each of the plurality of exterior walls fixably attached to a different one of the plurality of exterior wall frames; a plurality of doors, each of the plurality of doors having a geometric cutout disposed along a centerline of each of the plurality of doors, and each of the plurality of doors having a hand slot; a plurality of transparent panels.

### FIELD

The present disclosure relates to a residential lift enclosure and lift system and, more particularly, to a customizable residential lift enclosure and lift system constructed from low-cost materials.

### BACKGROUND

Current projections show that an estimated 27% of people in the United States and 1 billion people worldwide have some form of disability, that may limit mobility. Furthermore, movement of large household items can pose a challenge, even for individuals with no disability. Current residential elevator systems require extensive modification to the interior of a dwelling, and are prohibitively expensive, ranging from 35-70 thousand dollars.

As can be seen, there is a need for a customizable residential lift enclosure and lift system made from low-cost materials.

### SUMMARY

In one aspect of the present disclosure, a residential lift housing, a residential lift and a system for a residential lift. The purpose of the present invention is to eliminate, among other things, the aforementioned drawbacks of background-art solutions. More particularly, the purpose of the invention is to produce a lower-cost residential lift enclosure and lift system. The housing according to the present invention includes a plurality of footings; a plurality of corner posts, each of the plurality of corner posts anchored to a different one of the plurality of footings; a plurality of interior frames, disposed in between less than all of the plurality of corner posts to form a plurality of exterior wall frames and a door frame; a plurality of exterior walls, each of the plurality of exterior walls fixably attached to a different one of the plurality of exterior wall frames; a plurality of door hasps fixably attached to a first side of the door frame; a plurality of hinges fixably attached to a second side of the door frame; a plurality of doors, each of the plurality of doors having a geometric cutout disposed along a centerline of each of the plurality of doors, and each of the plurality of doors having a hand slot, wherein the plurality of doors are fixably attached to the plurality of hinges and removably secured to the plurality of door hasps; a plurality of transparent panels, each of the plurality of transparent panels fixably attached to a different one of the plurality of doors, covering the geometric cutout, to form a viewing window for each of the plurality of doors; and a roof fixably attached to each of the plurality of corner posts.

The lift according to the present invention includes a platform; a boom; a safety cage secured, at a base of the safety cage, to the platform, wherein an apex of the safety cage is secured to a landing pad; and a chassis having a plurality of wheels mounted thereupon, wherein the boom is secured at first end to the platform and secured at a second end to the chassis. Further aspects of the invention, include that the inventive lift is enclosed within the inventive housing to form a residential lift system.

### BRIEF DESCRIPTION OF THE DRAWINGS

FIG. 1 is a perspective view of the residential lift system showing installation, according to aspects of the present disclosure;

FIG. 2 is a perspective view of the residential lift system, according to aspects of the present disclosure;

FIG. 3 is a perspective view of the residential lift system with door opened, according to aspects of the present disclosure;

FIG. 4 is a frontal view of the residential lift system with door closed, according to aspects of the present disclosure;

FIG. 5 is a frontal view of the residential lift system with door removed to expose interior details, according to aspects of the present disclosure;

FIG. 6 is an exploded perspective view of the residential lift system with details shown therein, according to aspects of the present disclosure;

FIG. 7 is side view of the residential lift system with exterior wall removed to show extended lift, according to aspects of the present disclosure;

FIG. 8 is a side view of the residential lift system with exterior wall removed to show retracted lift, according to aspects of the present disclosure; and

FIG. 9 is a view of an exemplary residential installation of the residential lift system, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Current residential lift systems are cost-prohibitive for many consumers due to the type of materials used in construction, and costs associated with retrofitting the interior of a residence.

Broadly, an embodiment of the present disclosure provides a residential lift housing, a residential lift and a system for a residential lift wherein the housing is formed from low-cost commodity materials, provides adequate safety measures, and can be installed on the exterior of a resident.

Referring now to FIG. 1, FIG. 1 illustrates a residential lift housing, according to aspects of the present disclosure. The housing is formed of low-cost materials, is customizable in both function and aesthetics, and can be installed on the exterior of a residence to further reduce costs associated with construction. FIG. 1 illustrates the residential lift housing can be installed on an upper deck 38 and lower deck 40 with a deck extension 44. The residential lift housing can be formed on three sides with exterior panels 24, in a preferred embodiment can be formed of plywood. FIG. 1 illustrates the housing with two doors 26, however, it is contemplated that the number of doors 26 in the housing match the number of floors of the residence 46. FIG. 1 illustrates door hasps 34, which can be used to secure doors 26 in a locked position. Door hasps 34 can be unlocked by a user a hand slot 35 to access the door hasps 34. In a preferred embodiment, door hasps 34 are lockable/unlockable utilizing a biometric access/denial smart lock system. A door panel 28 can be cut out of the door and covered with a transparent material, such that a user actuating a lift on the interior of the housing can view the level of the lift relative to the floor. In a preferred embodiment, the transparent material can be plexiglass. The housing includes safety features such as a door warning sign 32 and a hand slot warning sign 33. Finally, the housing is protected from above by a roof 36. In a preferred embodiment, the roof can have four side panels, formed form two-by-six inch wood, and a roof panel secured to the side panels which can be made of ½ inch plywood.

While FIG. 1 illustrates various components of the residential lift housing, additional components can be added, and existing components can be removed.

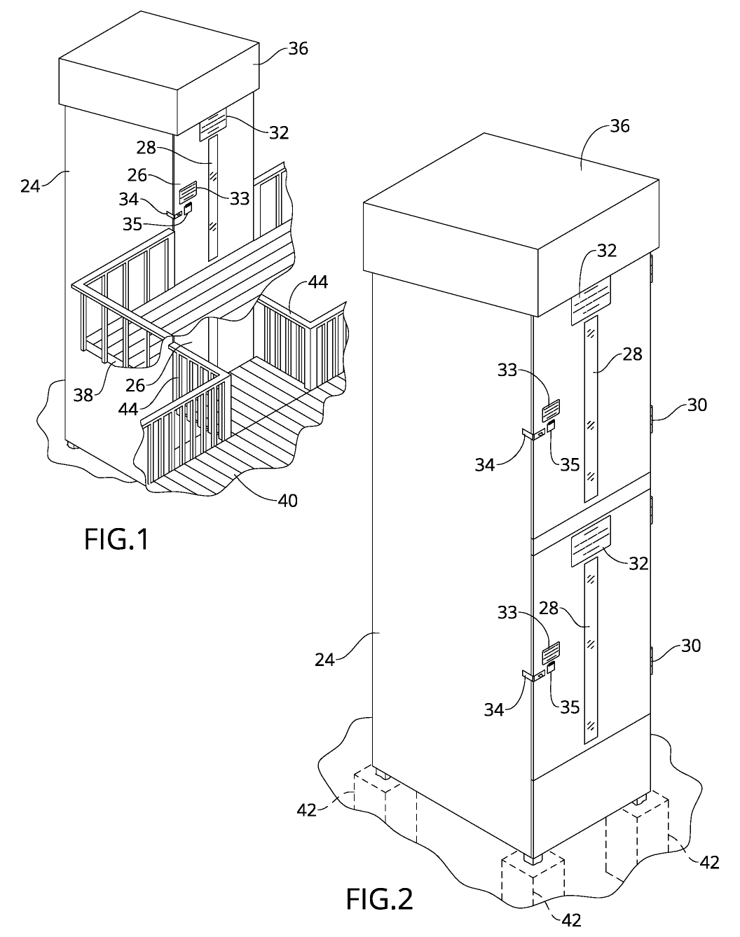

Referring now to FIG. 2, FIG. 2 illustrates further aspects of the residential housing lift, with deck assembly removed. FIG. 2 more clearly illustrates the door opening and locking mechanisms. For example, a door 26 can be fixable attached to the lift housing by hinges 30 and can be removably secured to the lift housing by door hasps 34. FIG. 2 further illustrates the anchoring mechanism for the lift housing, which can be footings 42. In a preferred embodiment the footings are formed of concrete.

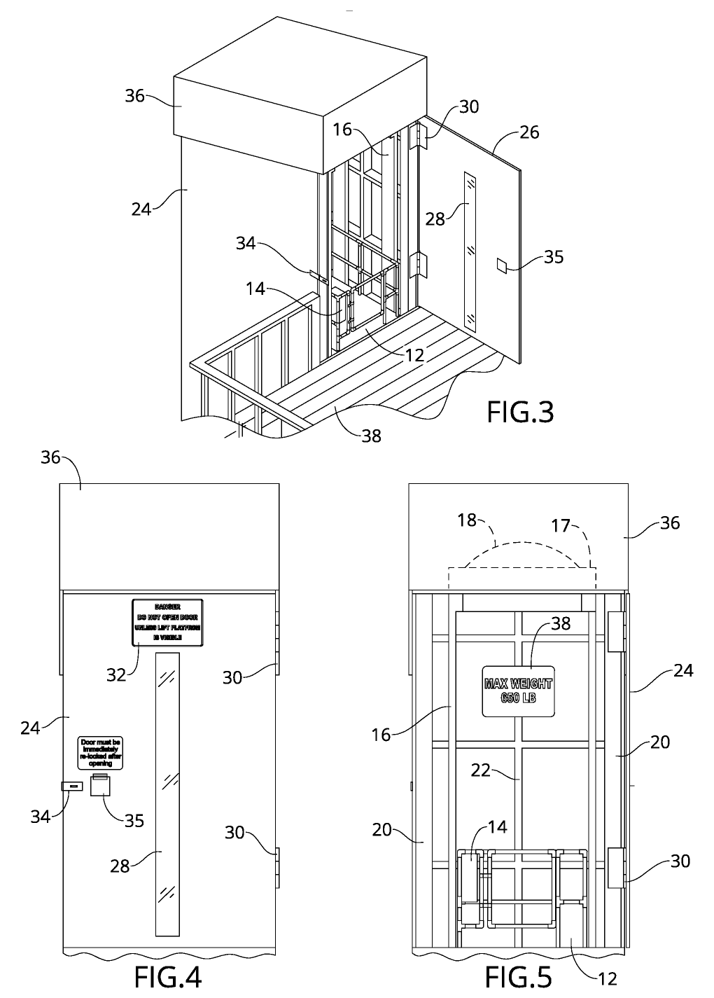

Referring now to FIG. 3, FIG. 3 illustrates further aspects of the residential housing lift with door 26 opened, to reveal details of the interior of the housing. FIG. 3 illustrates a lift basket on the interior of the lift housing. Specifically, FIG. 3 illustrates a lift basket 12, which can be used to transport an individual, group of individuals, or cargo, between floors. The lift basket 12 is partially enclosed in a lift basket frame 16, which provides safety to the lift payload. FIG. 3 further illustrates a lift control box 14, that is configured to control ascent and descent of the lift payload in a continuous manner. In the alternative, ascent and descent can be controlled by a remote control in a continuous manner, or both of the control box 14 and the remote control can be pre-programmed to raise/lower lift to specific heights corresponding to levels of a floor.

Referring now to FIG. 4, FIG. 4 illustrates a frontal view of a single level of the residential lift housing. Referring now to FIG. 5, FIG. 5 illustrates a frontal view of a single level of the residential lift housing with door 26 opened to reveal interior details. Specifically, FIG. 5 illustrates corner posts 20, which can be affixed to exterior panels 24 and can provide structural support for the lift housing. FIG. 5 further illustrates the upper frame 17 for lift basket frame 16, which can have a landing pad 18 affixed thereto. In a preferred embodiment, the landing pad 18 can be a shock absorbing pad to cushion contact between lift basket frame 16 and roof 36.

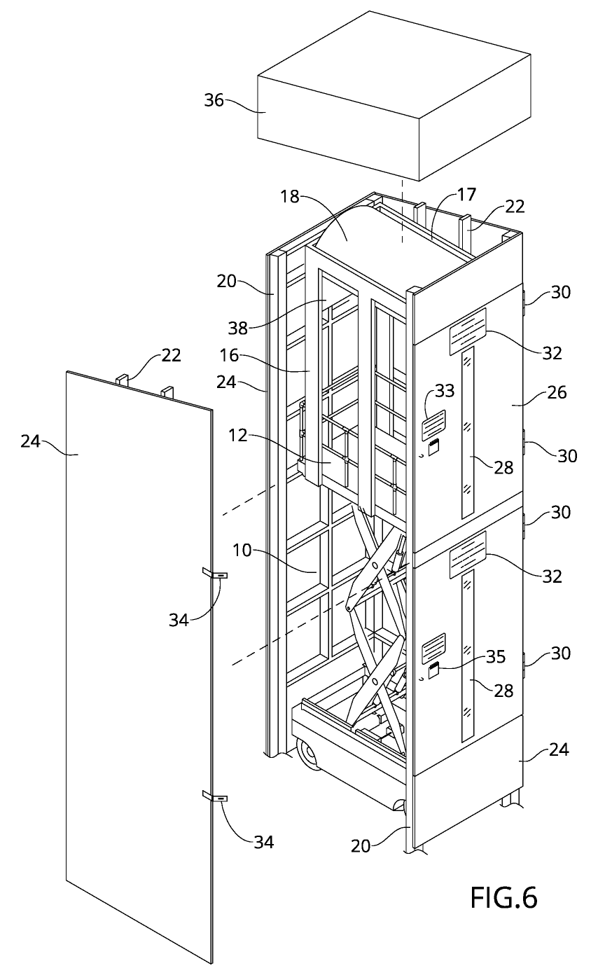

Referring now to FIG. 6, FIG. 6 illustrates a perspective view of the residential lift housing system with an exterior wall 26 removed to illustrate interior details. FIG. 6 illustrates aspects and reference numbers previously described along with new features described forthwith. FIG. 6 more clearly illustrates upper frame 17 and the installation of landing pad 18 on upper frame 17. Moreover, FIG. 6 more clearly illustrates corner posts 20, and the support that they can provide for the lift housing structure. Furthermore, FIG. 6 illustrates inner frame 22, which can be fixably attached to exterior wall 24 and corner post 20. In an exemplary embodiment, the lift housing includes three exterior walls 24 attached to three interior frames 22, which are subsequently attached to pairs of corner posts 20 to form a rectangular prism shape lift housing. Finally, FIG. 6 illustrates lift 10 installed within residential lift housing. In a preferred embodiment corner posts 20 can be formed of four-by-four inch lumber, the inner frame 22 can be formed of two-by-six inch lumber and the exterior walls can be formed of ½ inch plywood.

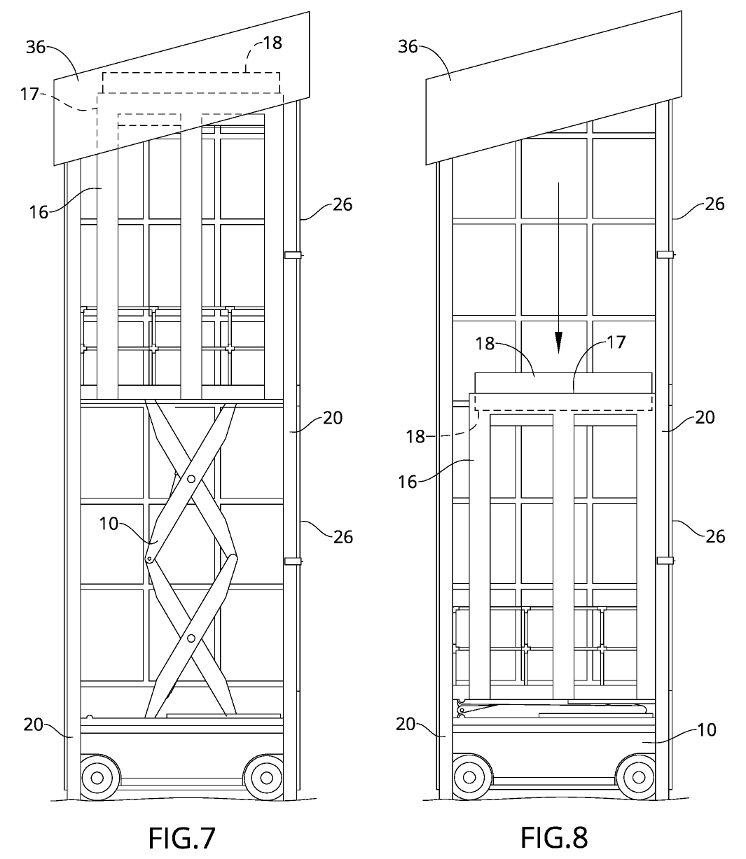

Referring now to FIG. 7-8, FIG. 7 illustrates a perspective view of the residential lift housing system with lift 10 fully extended, and FIG. 8 illustrates a perspective view of the residential lift housing system with lift 10 fully retracted. In a preferred embodiment, the lift 10 is controllable to actuate up/down utilizing a remote control, which can be any type of computing device, including but not limited to, a computer, laptop, mobile device, mobile phone, etc.

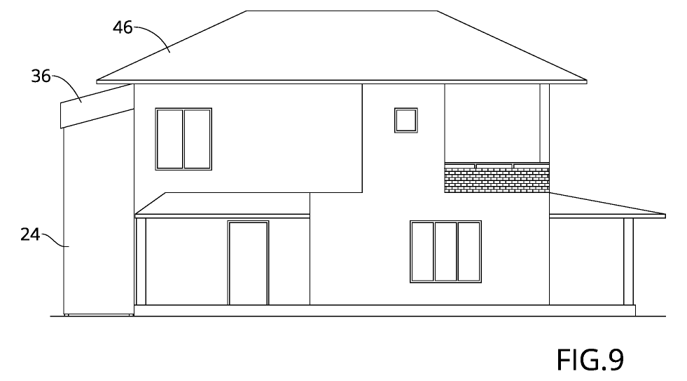

Referring now to FIG. 9, FIG. 9 illustrates the residential lift housing 24 with roof 36 installed on a residence 46. In a preferred embodiment, roof 36 can be a pitched roof to allow for runoff of precipitation.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A housing for a residential lift, the housing comprising:
a plurality of footings;
a plurality of corner posts, each of the plurality of corner posts anchored to a different one of the plurality of footings;
a plurality of interior frames, disposed in between less than all of the plurality of corner posts to form a plurality of exterior wall frames and a door frame;
a plurality of exterior walls, each of the plurality of exterior walls fixably attached to a different one of the plurality of exterior wall frames;
a plurality of door hasps fixably attached to a first side of the door frame;
a plurality of hinges fixably attached to a second side of the door frame;
a plurality of doors, each of the plurality of doors having a geometric cutout disposed along a centerline of each of the plurality of doors, and each of the plurality of doors having a hand slot, wherein the plurality of doors are fixably attached to the plurality of hinges and removably secured to the plurality of door hasps;
a plurality of transparent panels, each of the plurality of transparent panels fixably attached to a different one of the plurality of doors, covering the geometric cutout, to form a viewing window for each of the plurality of doors; and
a roof fixably attached to each of the plurality of corner posts.

2. The housing of claim 1, wherein the plurality of footings are made of concrete.

3. The housing of claim 1, wherein the roof further comprises: four side walls and a top wall fixably attached to the four side walls.

4. The housing of claim 3, wherein the roof is a pitched roof.

5. The housing of claim 1, wherein a shape of the geometric cutout is at least one of: a rectangle, a square, a circle, or a triangle.

6. The housing of claim 1, wherein the plurality of corner posts, the plurality of interior frames, the plurality of doors, and the plurality of exterior walls, are wooden.

7. A mobile lift, the mobile lift comprising:
a platform;
a boom;
a safety cage secured, at a base of the safety cage, to the platform, wherein an apex of the safety cage is secured to a landing pad; and
a chassis having a plurality of wheels mounted thereupon, wherein the boom is secured at first end to the platform and secured at a second end to the chassis.

8. The mobile lift of claim 7, wherein the boom comprises a scissor mechanism.

9. The mobile lift of claim 7, wherein the platform can be extended to a height of 2-35 feet, in continuous increments.

10. A residential lift system, the system comprising:
a plurality of footings;
a plurality of corner posts, each of the plurality of corner posts anchored to a different one of the plurality of footings;
a plurality of interior frames, disposed in between less than all of the plurality of corner posts to form a plurality of exterior wall frames and a door frame;
a plurality of exterior walls, each of the plurality of exterior walls fixably attached to a different one of the plurality of exterior wall frames;
a plurality of door hasps fixably attached to a first side of the door frame;
a plurality of hinges fixably attached to a second side of the door frame;
a plurality of doors, each of the plurality of doors having a geometric cutout disposed along a centerline of each of the plurality of doors, and each of the plurality of doors having a hand slot, wherein the plurality of doors are fixably attached to the plurality of hinges and removably secured to the plurality of door hasps;
a plurality of transparent panels, each of the plurality of transparent panels fixably attached to a different one of the plurality of doors, covering the geometric cutout, to form a viewing window for each of the plurality of doors; a roof fixably attached to each of the plurality of corner posts;
a platform;
a boom;
a safety cage secured, at a base of the safety cage, to the platform, wherein an apex of the safety cage is secured to a landing pad; and
a chassis having a plurality of wheels mounted thereupon, wherein the boom is secured at first end to the platform and secured at a second end to the chassis.
